(19) United States
(12) Patent Application Publication
(10) Pub. No.: US 2005/0008794 A1
(43) Pub. Date: Jan. 13, 2005

(54) Ink-jet recording media having a microporous coating comprising cationic fumed silica and cationic polyurethane and methods for producing the same

(75) Inventors: Tom Graczyk, Branford, CT (US); Shailesh Mody, Middletown, CT (US)

Correspondence Address: BARLOW, JOSEPHS & HOLMES, LTD., 101 DYER STREET, 5TH FLOOR, PROVIDENCE, RI, 02903, US

(73) Assignee: Arkwright, Inc.

(21) Appl. No.: 10/616,580

(22) Filed: Jul. 10, 2003

(51) Int. Cl. B41M 5/00

(52) U.S. Cl. 428/32.24

(57) ABSTRACT

Inkjet recording media for producing high quality images using color printers are provided. The media comprise a substrate material, such as a paper, coated with an ink-receptive composition comprising an aqueous dispersion of cationic fumed silica particles and cationic polyurethane resin. The dispersion comprises at least 60% by weight of cationic fumed silica particles, and at least 14% by weight of cationic polyurethane resin based on solids. The coated ink-receptive layer is free of surface defects and has good ink-absorption properties. The invention also includes ink-jet recording media comprising a substrate coated with an ink-receptive underlayer and an ink-receptive top layer. The resulting media may have a semi-glossy surface finish. The surface gloss may be enhanced further by calendering the coated layer.

### BACKGROUND OF THE INVENTION

1. Field of the Invention

The present invention generally relates to imaging media suitable for use with small and wide format ink-jet color printers. Particularly, the invention relates to ink-jet recording media comprising a substrate material coated with an ink-receptive composition comprising an aqueous dispersion of cationic fumed silica particles and cationic polyurethane resin. The media can be used to produce high quality images (prints). The invention also includes ink-jet recording media comprising a substrate, such as a matte paper, coated with an ink-receptive underlayer and top layer. The resulting media have a semi-glossy or glossy surface finish.

2. Brief Description of the Related Art

The mass market for inkjet color printing has grown exponentially in recent years particularly in applications such as digital photo pictures, posters, and advertising banners. Small or wide format color ink-jet printers are used depending on the size of the media and intended end-use application. Generally, in an ink-jet printing process, liquid ink is squirted through very fine nozzles in a printer to form an image (print) directly on a recording medium. Typically, the ink-jet recording medium is a film or paper substrate coated with a specially designed ink-receiving coating. The quality of the final image or print is partly dependent on the structure of the ink-jet recording medium particularly the coating(s) composition and substrate material. The inks used in most ink-jet printers are aqueous-based inks containing molecular dyes or pigmented colorants. Water is the major component in aqueous-based inks. Small amounts of water-miscible solvents such as glycols and glycol ethers also may be present. Other ink-jet inks are non-aqueous based inks containing organic vehicles (e.g., hydrocarbon solvents) as the major component.

Improvements to the ink-jet recording materials have contributed to the growth in ink-jet color printing. Particularly, some ink-jet media can now form images having improved color brilliance and fidelity. Consistent image quality can be maintained over a wide temperature and humidity range, and the images can have good color-to-color edge sharpness, color rub-off, water resistance, and be feathering free. However, as often happens, one set of image qualities can be obtained only at the expense of another, thereby making it difficult to obtain all of the requisite image qualities.

The ink-jet industry is continuously attempting to develop media, which can produce higher quality prints with instant dry time and permanent water-fastness. The ink receiving coating has to be capable of absorbing a high amount of inks in a very short period of time to achieve these goals.

Commercially available ink-jet recording media typically have a swelling or porous ink-receptive coating. The mechanism for absorbing the aqueous vehicle found in aqueous inks depends on the type of ink-receptive coating. Swelling coatings are based on polymeric resins and the ink penetrates the coating via polymer swelling which is generally a slow process. After the image is printed, the printed surface remains saturated with the ink and the drying time is relatively long. In contrast, porous coatings are based on highly absorptive pigments and the ink quickly absorbs into the porous coating via capillary suction and the dry time is relatively short.

It is known that ink-receptive coatings containing certain cationic fumed silica and polymer binder can be prepared, and these coatings can be applied to a substrate material to produce ink-jet recording media.

For example, Bermel et al., U.S. Pat. No. 6,479,135 discloses an ink-jet recording element comprising a support having thereon a porous image-receiving layer comprising particles and a polyvinyl alcohol binder. The particles comprise a fumed metallic oxide (for example, cationic fumed silica), and the binder has an average viscosity greater than about 25 cps at 4% solids in an aqueous solution at 20° C.

Bermel et al., Published U.S. Patent Application 2002/0142139 describes an ink-jet recording element comprising a support having thereon, a porous image-receiving layer comprising particles, a polyvinyl alcohol binder and a cross-linking agent. The particles can be cationic fumed silica and have a primary particle size of from about 7 to about 40 nm in diameter, which may be aggregated up to about 300 nm. The cross-linking agent is present in an amount of at least about 20 weight % of the polyvinyl alcohol binder.

Bermel et al., U.S. Pat. No. 6,457,825 discloses an ink-jet printing method including the steps of: a) providing an ink-jet printer that is responsive to digital data signals; b) loading the printer with an ink-jet recording element comprising a support having thereon a porous image-receiving layer comprising particles (for example, cationic fumed silica), a polyvinyl alcohol binder and a cross-linking agent.

Morris et al., Published U.S. Patent Application 2003/0003277 discloses an ink-jet recording medium comprising a flexible substrate and a coating composition applied to the surface of the substrate. The coating composition comprises the product formed from the contact between fumed silica particles and at least one aminoorganosiloxane. The published application also discloses that the coating composition may contain a polyurethane resin as a binder.

It is also known that water dispersible cationic polyurethanes can be used in the ink receptive coating. For example, Saito, U.S. Pat. No. 6,140,412 discloses a water-proofing agent for ink-jet printing paper comprising an aqueous cationic polyurethane resin solution. The resin solution is prepared by dispersing or dissolving in water one or more types of cationic polyurethane resins obtained by neutralizing with acid or quaternizing with a quaternizing agent.

Muoyoshi et al., U.S. Pat. No. 6,187,430 discloses an inkjet recording sheet having a high surface gloss and ink absorbing properties. A cast-coated ink receiving layer containing fine silica particles with an average primary particle size of 3 to 40 nm and an average secondary particle size of 10 to 400 nm and a binder is formed on a substrate sheet. The cast coated layer comprises cationic polyurethane resin having a glass transition temperature of 40° C. or more.

Sunderrajan, U.S. Pat. No. 6,447,882 discloses an ink-jet recording element having an image-recording layer comprising an anionic binder and organic, cationic mordant, and a porous overcoat layer located over the image-recording layer. The porous overcoat layer comprises an inorganic pigment and an organic, anionic binder, wherein the refractive index of the inorganic pigment in the overcoat layer is at least 0.05 refractive index units less than the refractive index of the inorganic, anionic pigment in the image-receiving layer. The cationic mordant is a polymer latex dispersion, a water-soluble polymer solution or a cationic urethane dispersion.

Kaneko et al., Published U.S. Patent Application 2001/0004487 discloses an ink-jet recording material having a support and at least two ink-receptive layers. One layer contains at least one of a polymer latex and a resin emulsion in combination with solid fine particles. An upper layer contains fumed silica. The resin emulsion can be a nonionic or cationic polyurethane resin. The published patent application discloses that a cationic polymer is preferably added to the fumed silica-containing layer.

Voeght et al., Published U.S. Patent Application 2002/0192436 discloses an improved ink-jet recording material comprising a subbed polyester support. The front side of the support contains at least two ink-receiving layers based on polyvinyl alcohol with a top layer containing a cationic mordant (for example, a cationic polyurethane latex.)

The ink-jet industry is looking to develop new media capable of highly absorbing aqueous inks to form high quality images having good color density, brilliance, and resolution. Also, there is a continuous need to provide ink-jet recording medium having resistance to cracking, blistering and pinholes. The media should be capable of producing photo-quality prints from dye and pigmented inks over a broad range of ink loadings, temperature and humidity conditions. The present invention provides such media. It is a further object of this invention to provide a low cost and environmentally favorable means of manufacturing ink-jet recording media using aqueous-based coating formulations. Another object of the invention is to develop ink-jet media having a semi-glossy or glossy surface finish using matte paper substrates. These and other objectives, features, and advantages of the present invention will become apparent upon a review of the specification and claims herein.

### SUMMARY OF THE INVENTION

The present invention relates to aqueous coating compositions suitable for making ink-jet recording media. The coating composition comprises a dispersion of at least 60% by weight of cationic fumed silica particles, and at least 14% by weight of cationic polyurethane resin based on total weight of solids in the composition. In one embodiment, the dispersion may contain about 60 to about 86% by weight of cationic fumed silica, and about 14% to about 40% by weight of cationic polyurethane resin. The coating composition may comprise other water-soluble or water-dispersible polymers and additives. The cationic fumed silica particles can be primary particles having an average particle size in the range of about 3 nm to about 40 nm. Also, the fumed silica particles can comprise about 99.5% silica and 0.5% alumina. The coating composition can have a pH in the range of about 3.0 to about 7.0.

This invention also encompasses ink-jet recording media, which can be used to produce high quality prints on small and wide format color printers. The ink-jet recording medium comprises a substrate coated with an ink-receptive layer comprising at least about 60% by weight of cationic fumed silica particles, and at least about 14% by weight of cationic polyurethane resin based on total dry weight of the ink-receptive layer. The substrate may be paper, particularly a porous paper having water absorption as measured per a standard Cobb test (TAPPI Test Method T441) in one minute in the range of about 20 to about 100. For example, the paper can be a matte paper having a surface gloss in the range of about 2 to about 10. In another embodiment, the paper can be semi-glossy with a gloss in the range of about 10 to about 40.

The ink-jet recording medium may comprise multiple ink-receptive layers. For example, the substrate may be coated with an underlayer comprising a water-soluble or water-dispersible polymer. A top layer comprising at least about 60% by weight of cationic fumed silica particles, and at least about 14% by weight of cationic polyurethane resin, based on total dry weight of the top ink-receptive layer, may overlay the underlayer. The underlayer may comprise polyvinyl alcohol and precipitated silica. The substrate may be a paper, particularly a porous matte paper. Alternatively, the paper can be a substantially impermeable paper having a polymeric moisture barrier coating. In other embodiments, a polymeric film, comprising a polymer, such as polyesters, polycarbonates, polyethylene, polypropylene, polyvinyl chloride, polystyrene, polyacrylics, polyacetals, ionomers, and mixtures thereof can be used as the substrate. In still other instances, a metal foil such as aluminum foil or metal-coated substrates can be used as the substrate.

In addition, the invention includes new methods for manufacturing ink-jet recording media. The methods comprise the steps of: a) coating an underlayer comprising a pigment and a polymer selected from the group consisting of water-soluble and water-dispersible polymers onto the substrate and drying the underlayer. A dispersion comprising at least 60% by weight of cationic fumed silica particles, and at least 14% by weight of cationic polyurethane resin based on the total weight of dispersed solids may be coated over the underlayer. The underlayer may provide a matte-like finish, and the top layer may provide a semi-glossy finish. In one embodiment, the method further includes the step of calendering the top ink-receptive layer to produce a top layer having a glossy finish.

### DETAILED DESCRIPTION OF THE INVENTION

The present invention relates to ink-jet recording media comprising a substrate material coated an ink-receptive composition comprising an aqueous dispersion of cationic fumed silica particles and cationic polyurethane resin. The invention also includes ink-jet recording media comprising a substrate, such as a matte paper, coated with an ink-receptive underlayer and top layer. The resulting media have a semi-glossy or glossy surface finish after calendering.

Substrates

The inkjet recording media of the present invention are constructed using a suitable substrate material. For example, the substrate may be a paper material. Paper substrates are known in the ink-jet industry and any suitable paper may be used in the present invention. For example, plain papers, clay-coated papers, or polyolefin-coated papers may be used. Suitable paper substrates include, for example, “Color Copy” and “Ascent” available from International Paper; “Grade 0633” available from Domtar; Grades “D-64-CCB” available from Glatfelter; “Specialty Image Gloss C2S”, “Specialty Image Gloss CIS”, “Ultra Image Gloss C2S”, “Super Premium Gloss”, and “Sterling Ultra Cast Coated” available from Mead Westvaco; and “All Purpose Litho Hi-Brite”, and “Knightkote” available from Smart Papers. The base weight of the paper is typically in the range of about 70 grams per square meter (gsm) to about 260 gsm, and preferably in the range of about 150 gsm to about 220 gsm. The thickness of the paper is typically in the range of about 3 mils to about 10 mils. The paper substrate may be pretreated with conventional adhesion promoters to enhance adhesion of the ink-receptive layer to the paper or other suitable primer coatings. Polyethylene-coated papers are particularly suitable. The polyethylene coating acts as a moisture barrier layer and prevents the aqueous vehicle found in inks from permeating into the substrate paper. In this manner, paper curling, cockling, and other defects can be avoided.

The paper substrate can have different surface finishes. For example, glossy paper substrates, wherein the substrate has a relatively high surface gloss (greater than 40 points), can be used. In other embodiments, satin-like or semi-glossy substrates having surface gloss values in the range of about 10 to about 40 points may be used. In still other embodiments, matte-like substrates having surface gloss values of less than about 10 points may be used. The test methods used to evaluate the surface gloss (finish) of the substrate and ink-jet recording media are described further below.

Alternatively, the substrate may be a polymeric film comprising a polymer, such as, polyethylene, polypropylene, polyester, naphthalate, polycarbonates, polysulfone, polyether sulfone, poly(arylene sulfone), cellulose triacetate, cellophane, polyvinyl chloride, polyvinyl fluoride, polyimide, polyesters, polystyrene, polyacrylics, polyacetals, ionomers, and mixtures thereof. In other instances, a metal foil such as aluminum foil or a metal-coated material can be used as the substrate.

The substrate material has two surfaces. The first surface which is coated with the ink-receptive layer or layers in accordance with this invention may be referred to as the “front” or “imaging” surface. The second surface which is opposite to the first surface may be referred to as the “back” or “non-imaging” surface.

The substrate material is coated with an ink-receptive composition in accordance with the present invention to produce an ink-receptive layer. The ink-receptive layer comprises at least about 60% by weight cationic fumed silica and at least about 14% by weight cationic polyurethane resin based on total dry weight of the ink-receptive layer. The ink-receptive layer has a porous film-like structure with good cohesiveness and mechanical strength.

Ink-Receptive Layer

In general, the coating composition used to produce the ink-receptive layer is an aqueous dispersion comprising cationic fumed silica and cationic polyurethane resin. More particularly, the coating composition comprises a dispersion of at least 60% by weight of cationic fumed silica particles, and at least 14% by weight of cationic polyurethane resin based on total weight of solids in the composition. The aqueous coating dispersions of the present invention preferably have a total solids content of at least 20% by weight based on weight of the dispersion.

Regarding first the cationic fumed silica particles used to prepare the dispersions of this invention, such silica particles are commercially available. The silica particles, themselves, are available in the form of aqueous dispersions. Also, it is known in the art that fumed silica particles are distinguishable over colloidal and precipitated silica. As described in published Unites States Patent Applications US 2001/0004487, US 2003/0054145, and US 2002/0182380, fumed silica is made by a gaseous or dry process. In contrast, colloidal and other silica particles are made from a wet process. The differences between fumed and colloidal silica are also described in Degussa Technical Bulletin, Number 1, “Basic Characteristic of Aerosil” Degussa Corp. (August, 1993). It is understood that the cationic fumed silica particles may contain a trace amount of other compounds as is known in the art. For example, the silica content of the cationic fumed silica can be 99.5 weight percent and the alumina content of the fumed silica, measured as Al₂O₃, can be in the range of 0.05-0.5 weight percent. The surface charge of the dispersion of cationic fumed silica particles, measured as Zeta-Potential, can be at least 20 mV. The pH of the dispersion can be in the range of about 1 to 7 and the viscosity can be less than 500 cps. The absorption of the cationic fumed silica in ultra-violet (UV) light and visible light can decrease from 3.7 at 210 nm to 0.5 at 900 nm.

The cationic fumed silica particles used in the present invention may be in the form of primary particles or secondary aggregated particles. The average particle size of the primary particles should be in the range of about 3 nm to about 40 nm and preferably from about 5 nm to about 20 nm. When the average primary particle size of the silica is less than 3 nm, the coating layer has unsatisfactory ink-absorbing properties. It is believed that these poor properties are due to the fact that the interstitial spaces or pores between such primary silica particles are too small, and the ink cannot be effectively absorbed. When the average primary particle size of the silica is greater than 40 nm, the inkjet layer tends to have an unsatisfactory gloss. The average particle size of the aggregated silica particles (secondary particle size) should be in the range of about 10 nm to about 400 nm and preferably from about 20 nm to about 150 nm. When the average particle size of the silica aggregates is greater than 400 nm, the coating layer has unsatisfactory gloss due to light scattering problems.

Secondly, concerning the cationic polyurethane resins used in the present invention, such resins are commercially available as aqueous dispersions from various companies including, for example, Crompton USA (e.g., “Witcobond 213 and 215”); Daichi Kogyo Yakuhin K.K. Japan (e.g., “F-8564D” and “Superflex 600”); and Kindai Kagaku Kogyo K.K. (e.g., “Pertol N856”), The aqueous, cationic polyurethane dispersions used in the present invention typically have a solids content of at least 15% by weight based on the weight of the dispersion. The aqueous cationic polyurethane dispersions typically have pH in the range about 3.0 to about 7.0, a viscosity below 500 cps using Brookfield LVF 60 rpm, and surface tension in the range of 35 to 55 dynes/cm. The tensile strength of a film cast from the cationic polyurethane dispersions is typically in the range of 3000 to 8000 psi and elongation is in the range of 50 to 600 percent.

The aqueous cationic polyurethane resins act as a binder for the cationic fumed silica particles. The aqueous polyurethane resins have good ink-fixing properties, are capable of recording ink images having a high color density, and provide film-like layers having good strength and surface gloss. The aqueous polyurethane resins can be referred to as urethane emulsions, urethane lattices, or polyurethane lattices.

The aqueous polyurethane resins are dispersed or emulsified in a fine particle form in an aqueous medium. The dispersions have a particle size in the range of about 1 nm to about 1000 nm. Also, the aqueous polyurethanes used in the present invention provide a transparent solution or a semi-colloidal dispersion. It has been found that polyurethane dispersions having a milky or hazy appearance do not provide ink-receptive layers having sufficient gloss.

The aqueous polyurethane resins have an urethane bond (—NHCOO) in the main chain. They are based on aliphatic and cycloaliphatic polyisocyanates to improve light stability. The preferred compounds are hexamethylene diisocyanate and isophorone diisocyanate.

The second component of polyurethanes includes high and low molecular weight compounds having an active hydroxyl group or amino group. The high molecular weight compounds include polyesterdiols, polyetherdiols, and polycarbonatediols the low molecular weight compounds include glycol such as ethylene glycol, 1,4-butanediol, and 1,6 hexanediol and diamine, for example, isopropyldiamine and hexamethylenediamine.

The cationic polyurethane resins can be manufactured by introducing cationic groups, for example, tert-amino groups, into the polymer and neutralizing or converting the resultant cationic polymer into a quaternary salt thereof with an acid.

In practice, the aqueous dispersion of cationic fumed silica is mixed with the aqueous dispersion of polyurethane resin to prepare the ink-receptive coating formulation of the present invention. For purposes of the present invention, it is important that the ink-receptive coating formulation be a sufficiently stable aqueous dispersion and that the solids not precipitate out. The aqueous dispersion of cationic fumed silica particles and cationic polyurethane resins preferably has a Zeta-Potential of at least 20 mV, a pH in the range of about 3.0 to about 7.0, and a viscosity less than 700 cps

It has been found that not all coating compositions containing cationic fumed silica and cationic polyurethane are suitable for use in this invention. As shown in the following comparative examples, some coating compositions containing cationic fumed silica are not sufficiently stable

In addition, the ink-receptive coating may contain additives such as pigments, surface active agents that control the wetting or spreading action of the coating, anti-static agents, suspending agents, acidic compounds to control the pH of the coating, optical brighteners, UV light stabilizers, UV absorbers, de-foaming agents, humectants, waxes, plasticizers, and the like.

The above-described ink-receptive layer is capable of absorbing aqueous-based inks to form images (prints) having dense bright colors, sharp color-to color boundaries, freedom from feathering, good water bleed-resistance, good wet rub-resistance, clean and bright backgrounds, uniform color fill, good image resolution and instant dry time.

Coated Underlayers

In the present invention, the paper substrate may be coated with multiple ink-receptive layers. Generally, the substrate can be first coated with a ink-receptive underlayer, and the above-described ink-receptive layer comprising cationic fumed silica and cationic polyurethane can be applied as a top (second) layer over this underlayer.

The polymeric ink-receptive underlayer can be prepared from a coating formulation comprising at least one water-soluble binder resin and pigments. Suitable water-soluble binder resins include, for example, those selected from the group consisting of polyvinyl alcohols; modified polyvinyl alcohols (e.g., carboxyl-modified PVA, silicone-modified PVA, maleic acid-modified PVA, and itaconic acid-modified PVA); poly(vinyl pyrrolidone); vinyl pyrrolidone copolymers; poly(2-ethyl-2-oxazoline); poly(ethylene oxide); poly(ethylene glycol); poly(acrylic acids); starch; modified starch (e.g., oxidized starch, cationic starch, hydroxypropyl starch, and hydroxyethyl starch), cellulose; cellulose derivatives (e.g., oxidized cellulose, cellulose ethers, cellulose esters, methyl cellulose, hydroxyethyl cellulose, carboxymethyl-cellulose, benzyl cellulose, phenyl cellulose, hydroxypropyl cellulose, ethyl hydroxyethyl cellulose, hydroxyethyl methyl cellulose, hydroxypropyl methyl cellulose, hydroxy butylmethyl cellulose, dihydroxypropyl cellulose, hydroxypropyl hydroxyethyl cellulose, chlorodeoxycellulose, aminodeoxycellulose, diethylammonium chloride hydroxyethyl cellulose, hydroxypropyl trimethyl ammonium chloride hydroxyethyl cellulose; alginates and water-soluble gums; dextrans; carrageenan; xanthan; chitin; proteins; gelatins; agar; and mixtures thereof.

Suitable dye absorbing particulates (pigments) for the first ink-receptive layer include, for example, those selected from the group consisting of synthetic silica and precipitated silica, kaolin, talc, clay, calcium sulfate, precipitated calcium carbonate, ground calcium carbonate, calcium carbonate-compounded silica, aluminum oxide, aluminum silicate, colloidal silica, colloidal alumina, lithopone, zeolite, hydrated halloysite, magnesium hydroxide, magnesium carbonate, barium sulfate, titanium dioxide, zinc oxide, zinc sulfate, and zinc carbonate. Specific examples of white plastic pigments that may be used include styrene-based plastic pigments, acrylic plastic pigments, polyethylene, micro-capsules, urea resin, and melamine resin.

Preferably, the first ink-receptive layer comprises a polyvinyl alcohol such as “Kuraray 235”, available from Kurrary Co. and precipitated silica pigment “Gasil HP 270” available from Ineos Silicas. The polyvinyl alcohol can be cross-linked for better water-fastness. These inkjet receptive coatings have excellent mechanical properties and are easy to coat. The coatings exhibit good scratch, fold and crack-resistance.

Ink-receptive coating formulations containing water-dispersible resins and pigments may also be prepared. Suitable water-dispersible resins include, for example, those selected from the group consisting of polyvinyl chloride; vinyl chloride copolymers (e.g., ethylene-vinyl chloride); polyvinylidene chloride; vinylidene chloride copolymers; acrylates; methacrylates; polyvinyl acetate; vinyl acetate copolymers (e.g., ethylene-vinyl acetate copolymers, and acrylic-vinyl acetate copolymers), polyacrylonitrile; polystyrene; styrene copolymers (e.g., styrene-maleic acid anhydride copolymers and styrene-butadiene copolymers); rubber latex; polyesters; vinyl-acrylic terpolymers, polyacrylonitrile; acrylonitrile copolymers (e.g., butadiene-acrylonitrile copolymers, butadiene-acrylonitrile-styrene terpolymers); polyurethanes; and mixtures thereof.

Furthermore, it is recognized that the ink-receptive layers of the present invention comprising cationic fumed silica and cationic polyurethane, as described above, may additionally contain such water-soluble and water-dispersible binders for improving the film-forming properties of the ink-receiving coating, quality of prints, ink drying times and gloss. However, the ink-receptive coating used to form the top layer preferably does not contain a polyvinyl alcohol binder, since such a binder tends to increase the viscosity of the coating formulation. Rather, the ink-receiving coating composition used for the top layer should have a relatively low viscosity. The low viscosity nature of the coating helps minimize coating defects when the composition is applied directly to the substrate or over the first ink-receptive layer.

Coated Underlayers Having a Matte-Like Finish

In one preferred embodiment of the present invention, a first ink-receptive layer may be coated as an underlayer on a paper substrate to provide a matte surface finish. This first underlayer has a porous structure and provides a matte surface finish typically in the range of 2 to 3 points, which is substantially the same as an uncoated matte paper. (In general, a matte surface finish has a gloss of less than about 10 points). Next, the above-described ink-receptive layer of this invention can be coated over the underlayer to produce a top layer. The application of this second (top) layer produces a coated medium having a semi-glossy or satin finish having a surface gloss of about 10 points or greater. (In general, a semi-glossy or satin surface finish has a gloss of in the range of about 10 to about 40 points.) This enhancement in gloss is obtained even though the top layer coating is not calendered. If the coating is calendered, then the improvement in gloss is even greater. A surface gloss of about 20 points or greater can be obtained when the coating is calendered.

Coating of Back Surface of Substrate

In addition, the back surface of the base substrate may be coated with a polymeric layer that further helps prevent moisture from penetrating into the base paper. The polymeric coating on the back surface of the paper enhances the paper's dimensional stability and helps minimize paper curling, cockling, and other defects. Such back surface coatings are generally known in the art. For example, the back surface coating may contain the above water-soluble or water-dispersible polymers and pigments.

The ink-receptive coating formulations of this invention may be applied to the front surface of the substrate and the back surface coating may be applied using conventional methods to form uniform coating layers. Suitable methods for coating the base paper include, for example, Meyer-rod, slot-die, roller, blade, wire bar, dip, solution extrusion, reverse roll, air-knife, curtain slide, doctor-knife, and gravure methods. The slot-die or Meyer-rod methods are preferred because of their ease of use. The aqueous-based coating formulation for the ink-jet recording medium is applied to a suitable substrate, and dried at a temperature of about 100° C. to remove the water. As discussed above, the ink-receptive layer may be calendered using a calendering apparatus such as a machine calender, a super calender or soft calender roll. In general, calendering an ink-receptive layer involves applying pressure in the range of 500 to 1500 per linear inch, with a hot roll temperature in the range from 20° C. to 120° C. and speed from 10 to 500 ft/min)

The relatively low and consistent viscosity of the ink-receptive coating formulation of the present invention is of particular advantage. In instances where multiple ink-receptive layers are applied to the substrate, the total dry coat weight of the ink-receptive layer is typically in the range of about 5 to about 40 g/m², and preferably about 10 to about 20 g/m².

The resulting inkjet recording media can be imaged by small and wide format ink-jet printers with aqueous or pigmented color inks to provide dense bright colors, sharp color to color boundaries, freedom from feathering, clean and bright backgrounds, uniform color fill and good image resolution, water bleed-resistance, wet rub resistance and instant dry time up to 400-percent ink loads.

The invention is further illustrated by the following Examples using the Test Methods described below, but these Examples should not be construed as limiting the scope of the invention. In the following Examples, the weight for all formula components is indicated in parts (grams), and where dispersions are used, the amount of solids in the dispersion is expressed as a weight percentage (e.g., 40%).

Test Methods

In the evaluation of the coating compositions, ink-jet recording media, and printed. (imaged) media as described in the below Examples, the following criteria and methodology were used.

Coating Appearance

The coatings were visually examined for surface dust, surface writing scratches, surface cracks and folding cracks. The properties of the coated media were evaluated on a relative scale of 1 to 5, where a rating of 1 means that the coating has the best properties with no surface defects.

Dry Time

Immediately after printing, a piece of bond paper was placed over the printed image and rolled with a smooth, heavy weight. Then the bond paper was separated from the printed image. The length of dye transfer on the bond paper was measured to calculate the time needed for the printed image to dry. The dry times of the printed media were evaluated on a relative scale of 1 to 5. The dry time was rated as 1 when there was no transfer of the inks to the bond paper. If there was a full transfer of at least one color strip to the bond paper, the dry time was rated as 5. Intermediate dry times were rated between the levels of 1 to 5.

Water-Fastness

An ink-jet recording medium was printed and then left to stand at room temperature for 24 hours. Next, a water drop was placed on the printed ink images for 15 seconds, and removed by wiping with a cotton swab and subsequently rubbing 5 times. The results of wet rub-resistance were evaluated on a relative scale of 1 to 5, where a rating of 1 means that the medium has the best water-fastness properties.

Image Quality

The image quality of the prints were evaluated subjectively on a relative scale of 1 to 5, where a rating of 1 means the best properties. The emphasis was focused on image quality at a 400-percent ink load and the inter- and background ink bleeding were evaluated primarily. Bleeding refers to the inks flowing out of its intended boundaries. Coalescence refers to the non-uniformity or puddling of the ink in solid filled areas.

Gloss

The surface gloss of the samples was measured using a Micro Tri-Gloss Meter (available from BYK Gardner, Inc.) according to the standard procedures described in the instrument manual provided by the manufacturer. The surface gloss was measured on the sheets prior to imaging (printing). The Micro-Tri Gloss Meter was calibrated at sixty (60) degrees using the standard supplied by the unit. The sample was placed on a flat surface and the surface gloss was measured at sixty (60) degrees.

### EXAMPLES

Working Example 1

The following coating composition was prepared. In one instance, the composition was coated on a glossy substrate (3 mil polyester film). In another instance, the composition was coated on a matte paper having a base weight of 176 g/m² and Cobb (TAPPI Test Method T441) value of 23 for 1 minute. The composition was coated using a Meyer rod and the substrate was dried at 120° C. for 1.5 minutes. The coat weight of ink-jet receptive layer was 15 to 20 g/m². The coating composition was an aqueous dispersion having a total solids content of 38 weight percent. In the ink-receptive layer, the silica pigment was present in an amount of 84 wt. % and the polyurethane resin was present in an amount of 16 wt. % based on total dry weight (solids). The gloss of the ink-receptive film layer was measured at 60 degrees and the results are reported below in Table 1.

| Component | Parts |
|---|---|
| Cationic Fumed Silica VP 5111, 40%, Degussa Corp. | 80 |
| Cationic polyurethane resin Witcobond W213, 30%, Crompton | 20 |

### COMPARATIVE EXAMPLE 1

For Comparative Example 1, an ink-jet recording medium was prepared in the same manner as described in Working Example 1, except the following coating composition was used. This coating composition contained only cationic fumed silica, VP 5111, available from Degussa Corp. The coating dispersion had a total solids content of 40 weight percent and formed a powdered layer with minimal cohesiveness and mechanical strength on the substrate. Evaluation results are reported below in below in Table 1.

| Component | Parts |
|---|---|
| Cationic fumed silica VP 5111, 40%, Degussa Corp. | 100 |

### COMPARATIVE EXAMPLE II

For Comparative Example II, an ink-jet recording medium was prepared in the same manner as described in Working Example 1, except the following coating composition was used. The coating dispersion had a total solids content of 27 weight percent. In the ink-receptive layer, the silica pigment was present in an amount of 84 wt. % and the polyvinyl alcohol was present in an amount of 16 wt. % based on total dry weight (solids). Evaluation results are reported below in Table 1.

| Component | Parts |
|---|---|
| Cationic fumed silica VP 5111, 40%, Degussa | 57.14 |
| Polyvinyl alcohol Celvol 523, 10%, Celanese | 42.86 |

### COMPARATIVE EXAMPLE III

For Comparative Example 111, an ink-jet recording medium was prepared in the same manner as described in Working Example 1, except the following coating composition was used. This coating composition contained only cationic colloidal silica Syloid 4000C available from Grace Davison. The coating dispersion had a total solids content of 40 weight percent and formed a powdered layer with minimal cohesiveness and mechanical strength on the substrate. Evaluation results are reported below in Table 1.

| Component | Parts |
|---|---|
| Cationic colloidal silica Sylojet 4000C, 40%, Grace Davison | 100 |

### COMPARATIVE EXAMPLE IV

For Comparative Example IV, an ink-jet recording medium was prepared in the same manner as described in Working Example 1, except the following coating composition was used. The coating dispersion had a total solids content of 27 weight percent. In the ink-receptive layer, the silica pigment was present in an amount of 84 wt. % and the polyvinyl alcohol resin was present in an amount of 16 wt. % based on total dry weight (solids). Evaluation results are reported below in Table 1.

Component Parts

| Component | Parts |
|---|---|
| Cationic colloidal silica Sylojet 4000C, 40%, Grace Davison | 57.14 |
| Polyvinyl alcohol Celvol 523, 10%, Celanese | 42.86 |

TABLE 1

| Substrate | Example | Gloss | Substrate | Example | Gloss |
|---|---|---|---|---|---|
| PET film | Uncoated | 62 | Matte Paper | Uncoated | 2-3 |
| PET film | Comparative | 52 | Matte Paper | Comparative I | 18 |
| | I | | | | |
| PET film | Comparative | 19 | Matte Paper | Comparative II | 3 |
| | II | | | | |
| PET film | Comparative | 60 | Matte Paper | Comparative | 20 |
| | III | | | III | |
| PET film | Comparative | 68 | Matte Paper | Comparative | 3-5 |
| | IV | | | IV | |
| PET film | Working | 54 | Matte Paper | Working | 10-20 |
| | Invention 1 | | | Invention 1 | |

Referring to Table 1 above, the uncoated matte paper had a surface gloss level of only 3 points. The ink-receptive coating containing only cationic fumed silica (Comparative Example I) had a gloss level of 18, but the coating dried to a powder and was not a film layer; the powdered coating did not have any cohesiveness or mechanical strength. When a coating composition containing cationic fumed silica and polyvinyl alcohol (Comparative Example II) was coated on a matte paper, the surface gloss was only 3 points. The ink-receptive coating containing only colloidal silica (Comparative Example 111) had a gloss level of 20 points, but the coating dried to a powder and was not a film layer; the powdered coating did not have any cohesiveness or mechanical strength. When a coating composition containing colloidal silica and polyvinyl alcohol (Comparative Example IV) was coated on a matte paper, the surface gloss was only 3 to 5 points. The PET film and matte paper coated with an ink-receptive coating of this invention (Working Example 1) exhibited high surface gloss.

TABLE 2

| | | | | | Gloss | Gloss | | | |
|---|---|---|---|---|---|---|---|---|---|
| | | Weight | Coat | Gloss | Before | After | | | Water |
| Matte Paper | Manufacture | G/m² | weight | Base | Calender | Calender | Bleed | Coalescent | fast |
| Grade 0633 | Domtar | 176 | 9.5 | 2.6 | 11.6 | 21.8 | 2 | 2.5 | 2 |
| Grade 0633 | Domtar | 176 | 15 | 2.6 | 13.4 | 32.7 | 1 | 1 | 1 |
| Grade 0790 | Domtar | 216 | 15 | 2.7 | 10.7 | 28.1 | 1 | 1 | 1 |
| Color Copy | Intl. Paper | 163 | 15 | 2.1 | 9.1 | 26.2 | 2 | 2 | 1 |
| Ascent | Intl. Paper | 176 | 15 | 2.2 | 10.1 | 27.4 | 2 | 2 | 1 |
| Grade D64-CCB | Glatfelter | 173 | 15 | 2.5 | 9.9 | 31.5 | 1 | 1 | 1 |
| Grade D64-CCB | Glatfelter | 138 | 15 | 2.4 | 9.3 | 29.8 | 1 | 1 | 1 |

Referring to Table 2 above, the coating composition of Working Example 1 was applied to several different matte paper substrates each having a base (initial) surface gloss in the range of 2 to 3 points. The coating composition provided a glossy layer on the matte papers, and the printed image on the media exhibited good print quality and water-fastness. In coating the matte papers, it was noted that the coating composition had very low viscosity and good thermal and long term stability which are necessary properties in industrial environments.

Further, as shown in Table 2, the gloss of the coated (non-calendered) matte papers was generally in the range of 10 to 15 depending on the weight of the base paper and weight of the coating composition. The coatings had excellent water-fastness, produced images having high ink density without bleed, exhibited good coalescence, and dried instantly. After calendering, the surface gloss improved to a level in the range of 25 to 35 points. The dry time and print quality did not deteriorate after calendering.

### COMPARATIVE EXAMPLE V

The following coating composition (dispersion) was prepared. The stability of the coating dispersion was observed and the results are described in below Table 3.

| Component | Parts |
|---|---|
| Cationic Fumed Silica PG 022, 20%, Cabot Corp. | 80 |
| Cationic polyurethane Witcobond W-213, 30%, Crompton | 20 |

### COMPARATIVE EXAMPLE VI

The following coating composition (dispersion) was prepared. The stability of the coating dispersion was observed and the results are described in below Table 3.

| Component | Parts |
|---|---|
| Cationic fumed silica CEP 031, 25%, Cabot Corp. | 80 |
| Cationic polyurethane Witcobond W-213, 30%, Crompton | 20 |

### COMPARATIVE EXAMPLE VII

The following coating composition (dispersion) was prepared. The stability of the coating dispersion was observed and the results are described in below Table 3.

| Component | Parts |
|---|---|
| Cationic fumed silica VP 5111, 40%, Degussa Corp | 80 |
| Non-ionic polyurethane Witcobond W-320, 30%, Crompton | 20 |

### COMPARATIVE EXAMPLE VIII

The following coating composition (dispersion) was prepared. The stability of the coating dispersion was observed and the results are described in below Table 3.

| Component | Parts |
|---|---|
| Cationic fumed silica PG 022, 20%, Cabot Corp. | 80 |
| Non-ionic polyurethane Witcobond W-320, 30%, Crompton | 20 |

### COMPARATIVE EXAMPLE IX

The following coating composition (dispersion) was prepared. The stability of the coating dispersion was observed and the results are described in below Table 3.

| Component | Parts |
|---|---|
| Cationic fumed silica VP 5111, 40%, Degussa Corp | 80 |
| Cationic polyurethane Patelacol IJ-21, 30%, | 20 |
| Dainippon Ink & Chemicals, Inc. | |

### COMPARATIVE EXAMPLE X

The following coating composition (dispersion) was prepared. The stability of the coating dispersion was observed and the results are described in below Table 3.

| Component | Parts |
|---|---|
| Cationic fumed silica VP 5111, 40%, Degussa Corp | 80 |
| Cationic polyurethane Exp CD-004, 30%, Exprix | 20 |

Referring to Table 3 below, it has been found that not all coating compositions containing cationic fumed silica and cationic polyurethane are suitable for use in this invention. As shown in Comparative Examples V and VI, aqueous dispersions of cationic fumed silica (20 wt. % solids) were incompatible with an aqueous dispersion of cationic polyurethane resin and immediately precipitated. In Comparative Example VII, an aqueous dispersion of cationic fumed silica (40 wt. % solids) was incompatible with an aqueous dispersion of non-Ionic polyurethane resin and precipitated. Interestingly in Comparative Examples IX and X an aqueous dispersion of cationic fumed silica (40 wt. % solids) was incompatible with some grades of cationic polyurethanes (i.e., Patelacol series and Exprix). Furthermore, even when the order of addition, dilution, and length of addition of the ingredients were changed, there was still precipitation. In other words, different orders of addition, dilution, and length of addition were tested, but in each instance the silica particles described in Table 3 precipitated out. The dispersion of polyurethane/silica particles was not sufficiently stable. Increasing the concentration of polyurethane in the composition improved stability somewhat, but the silica particles still precipitated out.

TABLE 3

| Status | Comparative | Comparative | Comparative | Comparative | Comparative | Comparative |
|---|---|---|---|---|---|---|
| Example | V | VI | VII | VIII | IX | X |
| Effect | Precipitate | Precipitate | Precipitate | Precipitate | Precipitate | Precipitate |

While not wishing to be bound by any theory, it is believed that the above cationic polyurethane dispersions in Table 3 had too high of a solids concentration, viscosity, or both. It is believed that after mixing the dispersions of cationic fumed silica with cationic polyurethane resins, the particles of polyurethane resins had stronger affinity to water than the silica particles.

Referring to Table 4 below, different coating compositions (dispersions) containing cationic fumed silica and different polymer binders were prepared. The stability of the coating dispersions was observed and the results are described in below Table 4.

TABLE 4

| | | | Polymer | |
|---|---|---|---|---|
| Cationic Fumed Silica | Polymer | Solution, % | pH | Effect |
| Cationic Fumed Silica VP 5111, | Polyvinyl pyrrolidone K-60 | 10 | 5.2 | Precipitate |
| 40%, Degussa Corp | | | | |
| Cationic Fumed Silica VP 5111, | Vinyl pyrrolidone-vinyl acetate | 25 | 4.1 | Precipitate |
| 40%, Degussa Corp | copolymer, W-635, W735 | | | |
| Cationic Fumed Silica VP 5111, | Polyetheylene glycol, Polyox | 10 | 7.2 | Precipitate |
| 40%, Degussa Corp | WRX-80 | | | |
| Cationic Fumed Silica VP 5111, | Polyethylene glycol, Carbowax | 20 | 5.4 | Stable |
| 40%, Degussa Corp | 1450 | | | |
| Cationic Fumed Silica VP 5111, | PolyDMAC | 20 | 4.0 | Precipitate |
| 40%, Degussa Corp | | | | |
| Cationic Fumed Silica VP 5111, | Methylcellulose E15 LV | 4 | 6.4 | Precipitate |
| 40%, Degussa Corp | | | | |
| Cationic Fumed Silica VP 5111, | Water soluble acrylic binder | 30 | 2.8 | Precipitate |
| 40%, Degussa Corp | polymer, TruDot DPX-8015-65 | | | |
| Cationic Fumed Silica VP 5111, | Water soluble acrylic binder | 10 | 2.8 | Stable |
| 40%, Degussa Corp | polymer, TruDot DPX-8015-65 | | | |
| Cationic Fumed Silica VP 5111, | Silicone modified polyvinyl | 10 | 6.6* | Precipitate |
| 40%, Degussa Corp | alcohol, R-1130 | | | |

*The dispersion with VP 5111 has pH 4.0

As shown in Table 4, aqueous dispersions of cationic fumed silica destabilizes and precipitates in the presence of many water soluble binders that are commonly used in ink-receiving coatings for ink-jet media. These binders include cellulose derivatives (methyl cellulose A15 and E15), cationic polymers used as-dye fixatives (polyDMAC), poly(vinyl pyrrolidone), vinyl pyrrolidone/vinylacetate copolymers (W-635, W-735), and acrylic polymer (TruDot DPX-8015-65). It is worth mentioning that silicone modified-polyvinyl alcohol at a concentration of 5 percent or more is not compatible with cationic fumed silica.

In the following Working Examples 2-12, different coating compositions comprising aqueous dispersions of cationic fumed silica particles and cationic polyurethane resins were prepared. In some instances, the coating compositions contained additional components such as colloidal silica and/or water soluble binders.

### WORKING EXAMPLE 2

For Working Example 2, an inkjet recording medium was prepared in the same manner as described in Working Example 1, except the following coating composition was used. The coating dispersion had a total solids content of 37 weight percent. In the ink-receptive layer, the silica pigment was present in an amount of 71 wt. % and the polyurethane resin was present in an amount of 29 wt. % based on total dry weight (solids). The composition was coated on a matte paper substrate having a base (initial) surface gloss of 2.5 to 2.6 points. An image was printed on the coated ink-jet recording medium using an Epson 980 Printer at 720 dpi in photo paper mode. The printed image was evaluated and the results are reported below in Table 5.

| Component | Parts |
|---|---|
| Cationic fumed silica VP 5111, 40%, Degussa Corp. | 65 |
| Cationic polyurethane resin Witcobond W213, 30%, Crompton | 35 |

### WORKING EXAMPLE 3

For Working Example 3, an ink-Jet recording medium was prepared in the same manner as described in Working Example 1, except the following coating composition was used. The coating dispersion had a total solids content of 37 weight percent. In the ink-receptive layer, the silica pigment was present in an amount of 84 wt. % and the polyurethane resin was present in an amount of 16 wt. % based on total dry weight (solids). The coating composition was coated on a matte paper substrate having a base (initial) surface gloss of 2.5 to 2.6 points. An image was printed on the coated ink-jet recording medium using an Epson 980 Printer at 720 dpi in photo paper mode. The printed image was evaluated and the results are reported below in Table 5.

| Component | Parts |
|---|---|
| Cationic fumed silica VP 5111, 40%, Degussa Corp. | 80 |
| Cationic polyurethane resin Witcobond W215, 30%, Crompton | 20 |

### WORKING EXAMPLE 4

For Working Example 4, an ink-jet recording medium was prepared in the same manner as described in Working Example 1, except the following coating composition was used. The coating composition had a total solids content of 37 weight percent. In the ink-receptive layer, the silica pigment was present in an amount of 71 wt. % and the polyurethane resin was present in an amount of 29 wt. % based on total dry weight (solids). The coating composition was coated on a matte paper substrate having a base (initial) surface gloss of 2.5 to 2.6 points. An image was printed on the coated ink-jet recording medium using an Epson 980 Printer at 720 dpi in photo paper mode. The printed image was evaluated and the results are reported below in Table 5.

| Component | Parts |
|---|---|
| Cationic fumed silica VP 5111, 40%, Degussa Corp. | 65 |
| Cationic polyurethane resin Witcobond W215, 30%, Crompton | 35 |

### WORKING EXAMPLE 5

For Working Example 5, an ink-jet recording medium was prepared in the same manner as described in Working Example 1, except the following coating composition was used. The coating composition had a total solids content of 38 weight percent. In the ink-receptive layer, the silica pigment was present in a total amount of 84 wt. % and the polyurethane resin was present in an amount of 16 wt. % based on total dry weight (solids). The coating composition was coated on a matte paper substrate having a base (initial) surface gloss of 2.5 to 2.6 points. An image was printed on the coated ink-jet recording medium using an Epson 980 Printer at 720 dpi in photo paper mode. The printed image was evaluated and the results are reported below in Table 5.

| Component | Parts |
|---|---|
| Cationic fumed silica VP 5111, 40%, Degussa Corp. | 61.5 |
| Cationic colloidal silica Sylojet 4000 C, 40%, GraceDavison | 18.5 |
| Cationic polyurethane resin Witcobond W213, 30%, Crompton | 20.0 |

### WORKING EXAMPLE 6

For Working Example 6, an ink-jet recording medium was prepared in the same manner as described in Working Example 5, except the following coating composition was used. The coating composition had a total solids content of 36 weight percent. In the ink-receptive layer, the silica pigment was present in a total amount of 84 wt. % and the polyurethane resin was present in an amount of 16 wt. % based on total dry weight (solids). The coating composition was coated on a matte paper substrate having a base (initial) surface gloss of 2.5 to 2.6 points. An image was printed on the coated ink-jet recording medium using an Epson 980 Printer at 720 dpi in photo paper mode. The printed image was evaluated and the results are reported below in Table 5.

| Component | Parts |
|---|---|
| Cationic fumed silica VP 5111, 40%, Degussa Corp. | 58.0 |
| Cationic colloidal silica Cartacoat K 302 C, 30%, Clarient | 23.2 |
| Cationic polyurethane resin Witcobond W213, 30%, Crompton | 18.8 |

### WORKING EXAMPLE 7

For Working Example 7, an ink-jet recording medium was prepared in the same manner as described in Working Example 5, except the following coating composition was used. The coating composition had a total solids content of 36 weight percent. In the ink-receptive layer, the silica pigment was present in a total amount of 84 wt. % and the polyurethane resin was present in an amount of 16 wt. % based on total dry weight (solids). The coating composition was coated on a matte paper substrate having a base (initial) surface gloss of 2.5 to 2.6 points. An image was printed on the coated ink-jet recording medium using an Epson 980 Printer at 720 dpi in photo paper mode. The printed image was evaluated and the results are reported below in Table 5.

| Component | Parts |
|---|---|
| Cationic fumed silica VP 5111, 40%, Degussa Corp. | 58.0 |
| Cationic colloidal silica Cartacoat K 303 C, 30%, Clarient | 23.2 |
| Cationic polyurethane resin Witcobond W215, 30%, Crompton | 18.8 |

### WORKING EXAMPLE 8

For Working Example 8, an inkjet recording medium was prepared in the same manner as described in Working Example 1, except the following coating composition was used. The coating composition had a total solids content of 38 weight percent. In the ink-receptive layer, the silica pigment was present in a total amount of 84 wt. % and the polyurethane resin was present in an amount of 16 wt. % based on total dry weight (solids). The coating composition was coated on a matte paper substrate having a base (initial) surface gloss of 2.5 to 2.6 points. An image was printed on the coated ink-jet recording medium using an Epson 980 Printer at 720 dpi in photo paper mode. The printed image was evaluated and the results are reported below in Table 5.

| Component | Parts |
|---|---|
| Cationic fumed silica VP 5111, 40%, Degussa Corp. | 80 |
| Cationic polyurethane resin Witcobond W213, 30%, Crompton | 10 |
| Acrylic binder TruDot DPX-8015-65, 32%, MeadWestvaco | 10 |

### WORKING EXAMPLE 9

For Working Example 9, an ink-jet recording medium was prepared in the same manner as described in Working Example 1, except the following coating composition was used. The coating composition had a total solids content of 38.2 weight percent. In the ink-receptive layer, the silica pigment was present in a total amount of 71.2 wt. % and the polymeric resins were presented in an amount of 28.8 wt. % based on total dry weight (solids). The coating composition was coated on a matte paper substrate having a base (initial) surface gloss of 2.5 to 2.6 points. An image was printed on the coated ink-jet recording medium using an Epson 980 Printer at 720 dpi in photo paper mode. The printed image was evaluated and the results are reported below in Table 5.

| Component | Parts |
|---|---|
| Cationic fumed silica VP 5111, 40%, Degussa Corp. | 68.0 |
| Cationic polyurethane resin Witcobond W213, 30%, Crompton | 18.3 |
| Cationic polystyrene latex TruDot P2502LS, 40%, Mead Westvaco | 13.7 |

### WORKING EXAMPLE 10

For Working Example 8, an ink-jet recording medium was prepared in the same manner as described in Working Example 1, except the following coating composition was used. The coating composition had a total solids content of 38 weight percent. In the ink-receptive layer, the silica pigment was present in a total amount of 84 wt. % and the polyurethane resin was present in an amount of 16 wt. % based on total dry weight (solids). The coating composition was coated on a matte paper substrate having a base (initial) surface gloss of 2.5 to 2.6 points. An image was printed on the coated ink-jet recording medium using an Epson 980 Printer at 720 dpi in photo paper mode. The printed image was evaluated and the results are reported below in Table 5.

| Component | Parts |
|---|---|
| Cationic fumed silica VP 5111, 40%, Degussa Corp. | 68.0 |
| Cationic polyurethane resin Witcobond W213, 30%, Crompton | 18.3 |
| Cationic styrene acrylic H1Q027, 40%, Specialty Polymers | 13.7 |

### WORKING EXAMPLE 11

For Working Example 9, an ink-jet recording medium was prepared in the same manner as described in Working Example 1, except the following coating composition was used. The coating composition had a total solids content of 38 weight percent. In the ink-receptive layer, the silica pigment was present in a total amount of 84 wt. % and the polyurethane resin was present in an amount of 16 wt. % based on total dry weight (solids). The coating composition was coated on a matte paper substrate having a base (initial) surface gloss of 2.5 to 2.6 points. An image was printed on the coated ink-jet recording medium using an Epson 980 Printer at 720 dpi in photo paper mode. The printed image was evaluated and the results are reported below in Table 5.

| Component | Parts |
|---|---|
| Cationic fumed silica VP 5111, 40%, Degussa Corp. | 80 |
| Cationic polyurethane Pertol N856, 30%, | 20 |
| Kindai Kagaku Kogyo K.K. | |

### WORKING EXAMPLE 12

For Working Example 10, an ink-jet recording medium was prepared in the same manner as described in Working Example 1, except the following coating composition was used. The coating composition had a total solids content of 38 weight percent. In the ink-receptive layer, the silica pigment was present in a total amount of 84 wt. % and the polyurethane resin was present in an amount of 16 wt. % based on total dry weight (solids). The coating composition was coated on a matte paper substrate having a base (initial) surface gloss of 2.5 to 2.6 points. An image was printed on the coated ink-jet recording medium using an Epson 980 Printer at 720 dpi in photo paper mode. The printed image was evaluated and the results are reported below in Table 5.

| Component | Parts |
|---|---|
| Cationic fumed silica VP 5111, 40%, Degussa Corp. | 80 |
| Cationic polyurethane resin F-8564D, 30%, | 20 |
| Daichi Kogyo Yakuhin K.K. | |

TABLE 5

| | | Gloss | Gloss | | | |
|---|---|---|---|---|---|---|
| | Gloss | Before | After | | | |
| Formula | Base | Calender | Calender | Bleed | Coalescent | Water fast |
| 2 | 2.6 | 18.6 | 41.2 | 2 | 2 | 1 |
| 3 | 2.5 | 9.6 | 32.4 | 1 | 1 | 1 |
| 4 | 2.6 | 14.7 | 36.1 | 2 | 2 | 1 |
| 5 | 2.6 | 15.4 | 34.3 | 2 | 1 | 1.5 |
| 6 | 2.5 | 17.8 | 37.0 | 2.5 | 1 | 1 |
| 7 | 2.6 | 8.5 | 27.2 | 2 | 1.5 | 1 |
| 8 | 2.6 | 16.3 | 25.3 | 1.5 | 1.5 | 1 |
| 9 | 2.6 | 11.6 | 34.2 | 2 | 1 | 1 |
| 10 | 2.5 | 9.4 | 29.3 | 2 | 1 | 1 |
| 11 | 2.6 | 10.3 | 33.6 | 1 | 1 | 1 |
| 12 | 2.6 | 11.4 | 35.4 | 1 | 1 | 1 |

Referring to Table 5 above, the ink-jet recording media coated with the compositions of Working Examples 2-8 produced printed images having instantaneous dry time and high image quality (ratings in the range of 1-2 for bleeding and coalescence). In addition, the printed images had excellent water fastness as measured per a wet rub test (ratings of 1). Further, the coating compositions provided a glossy layer on the matte paper substrate. Particularly, the surface gloss was in the range of 15 to 20 points before calendering and in the range of 30 to 40 points after calendering. The print quality and dry time did not deteriorate after calendering.

Coated Underlayers

### WORKING EXAMPLE 13

The following ink-jet receiving coating composition was prepared and was coated as an underlayer (first layer) on a 100 lb All Purpose Litho High Brite matte paper (base weight of 148 g/m²) available from Smart Papers. The matte paper was pre-coated with a barrier layer based on terpolymer of acrylonitrile-styrene-acrylate. The impermeable matte paper substrate had Cobb (TAPPI Test Method T441) value of no greater than 2 at minutes. The following ink-receiving composition was coated using a Meyer rod and the substrate was dried at 120° C. for 1.5 minutes. The coating composition for the first layer had a total solids content of 12 weight percent, and the pigment to binder ratio was 1.68. The coat weight of the first layer was 15 g/m². Then, the coating composition of either Working Example 1, 2, or 3 was applied as a top layer (or second layer) over the first layer to form a coated ink-jet recording medium having a two ink-receptive layered structure. The ink-jet recording medium was evaluated and the results are reported in Table 6 below.

First Ink Receptive Layer (Underlayer)

| Component | Parts |
|---|---|
| Water | 49.25 |
| Polyvinyl alcohol PVA-235, 10%, Kuraray Co. | 42.00 |
| Surfonyl CT-136, Air Products | 0.30 |
| Precipitated silica Gasil HP270, Ineos Silicas | 7.65 |
| Glyoxal, 40% | 0.80 |

### WORKING EXAMPLE 14

For Working Example 14, an ink-jet recording medium having two coated ink-receptive layers was prepared in the same manner as described in Working Example 13, except the following coating composition was applied as the first ink-receptive layer. The composition used to form the first ink-receptive layer had a total solids content of 16 weight percent, and the pigment to binder ratio was 2.02. The ink-jet recording medium was evaluated and the results are reported in Table 6 below.

First Ink Receptive Layer (Underlayer)

| Component | Parts |
|---|---|
| Water | 40.23 |
| Polyvinyl alcohol PVA-235, 10%, Kuraray Co. | 48.16 |
| Surfonyl CT-136, Air Products | 0.38 |
| Precipitated silica Gasil HP270, Ineos Silicas | 10.47 |
| Glyoxal, 40% | 0.762 |

### WORKING EXAMPLE 15

For Working Example 15, an ink-jet recording medium having two coated ink-receptive layers was prepared in the same manner as described in Working Example 13, except the following coating composition was applied as the first ink-receptive layer. The composition used to form the first ink-receptive layer had a total solids content of 12 weight percent, and the pigment to binder ratio was 1.69. The ink-jet recording medium was evaluated and the results are reported in Table 6 below.

First Ink Receptive Layer (Underlayer)

| Component | Parts |
|---|---|
| Water | 49.25 |
| Polyvinyl alcohol PVA-235, 10%, Kuraray Co. | 42.00 |
| Surfonyl CT-136, Air Products | 0.30 |
| Precipitated silica Syloid 72, Grace Davison | 7.65 |
| Glyoxal, 40% | 0.80 |

### WORKING EXAMPLE 16

For Working Example 16, an ink-jet recording medium having two coated ink-receptive layers was prepared in the same manner as described in Working Example 13, except the following coating composition was applied as the first ink-receptive layer. The composition used to form the first ink-receptive layer had a total solids content of 13 weight percent, and the pigment to binder ratio was 1.41. The inkjet recording medium was evaluated and the results are reported in Table 6 below.

First Ink Receptive Layer (Underlayer)

| Component | Parts |
|---|---|
| Water | 59.70 |
| Polyvinyl alcohol PVA-235, 10%, Kuraray Co. | 30.33 |
| Surfonyl CT-136, Air Products | 0.33 |
| Precipitated silica Gasil HP 270, Ineos Silicas | 7.65 |
| Styrene/acrylate copolymer H1Q078, Specialty Polymers | 4.92 |
| Glyoxal, 40% | 0.80 |

TABLE 6
(Multiple Ink-Receptive Layers).

| | | | Top | | | | | | |
|---|---|---|---|---|---|---|---|---|---|
| | Underlayer | Top | Layer | | | | | | |
| Underlayer | Coat | Layer | Coat | Gloss | Gloss of 2^{nd} Top Layer | | | | |
| Working | Weight, | Working | Weight | of 1st | | Coated and | | | Water |
| Example | g/m² | Example | g/m² | Layer | Coated | Calendered | Bleed | Coalescence | fastness |
| 13 | 15 | 1 | 20 | 2.5 | 18.5 | 36.1 | 1 | 1 | 1 |
| 14 | 15 | 1 | 15 | 2.4 | 16.9 | 37.2 | 1 | 1 | 1 |
| 13 | 15 | 2 | 15 | 2.6 | 19.1 | 40.2 | 1 | 1 | 1 |
| 13 | 15 | 3 | 15 | 2.5 | 9.3 | 23.5 | 1 | 1 | 1 |

Referring to Table 6 above, the ink-jet recording media having a structure comprising two ink-receptive coating layers (Working Examples 11-15) were evaluated for performance properties. An image was printed on the coated ink-jet recording medium using a HP 2500 Printer with dye inks at a semi-glossy photo paper mode. The two-layered structure produced printed images having instantaneous dry times and high image quality (ratings in the range of 1-2 for bleeding and coalescence). In addition, the printed images had excellent water fastness as measured per a wet rub test (ratings of I). Further, the coating compositions provided a semi-glossy layer on the matte paper substrate. Particularly, the surface gloss was in the range of 10 to 20 points before calendering and in the range of 25 to 40 points after calendering. The print quality and dry time did not deteriorate after calendering. It was also found that the gloss properties of the second ink-receptive layer (before and after calendering) were partly dependent upon the coat weight of the second layer. Higher coat weights resulted in higher surface gloss values for the second layer.

It is appreciated by those skilled in the art that various changes and modifications can be made to the description and illustrated embodiments herein without departing from the spirit of the present invention. All such changes and modifications are intended to be covered by the appended claims.

1. An aqueous coating composition for making an ink-jet recording medium, comprising a dispersion of: a) at least 60% by weight of cationic fumed silica particles, and b) at least 14% by weight of cationic polyurethane resin based on total weight of solids in the composition.

2. The coating composition of claim 1, comprising: a) about 60% to about 86% by weight of cationic fumed silica particles, and b) about 14% to about 40% by weight of cationic polyurethane resin.

3. The coating composition of claim 1, further comprising a water-soluble polymer selected from the group consisting of cationic acrylic polymers and copolymers, acrylic/acrylamide copolymers, polyvinyl alcohol/N-vinylformamide copolymers, and acrylamide polymers.

4. The coating composition of claim 1, further comprising a water-dispersible polymer selected from the group consisting of cationic acrylic polymers and copolymers, cationic styrene/acrylic copolymers, and cationic polystyrene latexes

5. The coating composition of claim 1, further comprising an additive selected from the group consisting of pigments, surface active agents, anti-static agents, optical brighteners, UV light stabilizers, UV absorbers, defoaming agents, humectants, waxes, and plasticizers.

6. The coating composition of claim 1, wherein the silica particles are primary particles having an average particle size in the range of about 3 nm to about 40 nm.

7. The coating composition of claim 1, wherein the silica particles comprise about 99.5% by weight silica and about 0.005% to about 0.5% by weight alumina.

8. The coating composition of claim 1, wherein the composition has a pH in the range of about 3.0 to about 7.0.

9. The coating composition of claim 1, wherein the composition has a zeta potential of at least 20 mV.

10. An ink-jet recording medium, comprising a substrate coated with an ink-receptive layer comprising: a) at least 60% by weight of cationic fumed silica particles, and b) at least 14% by weight of cationic polyurethane resin based on total dry weight of the ink-receptive layer.

11. The ink-jet recording medium of claim 10, wherein the substrate is a paper.

12. The ink-jet recording medium of claim 11, wherein the substrate is a porous paper having water absorption as measured per a Cobb TAPPI Test Method T441 in one minute in the range of about 20 to about 100.

13. The ink-jet recording medium of claim 11, wherein the paper is a matte paper having a gloss in the range of about 2 to about 10.

14. The ink-jet recording medium of claim 11, wherein the paper has a base weight in the range of about 70 to about 260 g/m².

15. The ink-jet recording medium of claim 10, wherein the weight of the weight of the ink-receptive layer is in the range of about 5 to about 40 g/m².

16. An ink-jet recording medium, comprising a substrate coated with a) an ink-receptive underlayer comprising a pigment and a polymer selected from the group consisting of a water-soluble and water dispersible polymer and b) an ink-receptive top layer comprising: a) at least 60% by weight of cationic fumed silica particles, and b) at least 14% by weight of cationic polyurethane resin based on total dry weight of the top layer.

17. The ink-jet recording medium of claim 16, wherein the ink-receptive underlayer comprises pigment and a water-soluble polymer selected from the group consisting of poly(vinyl alcohol), poly(vinyl pyrrolidone); poly(2-ethyl-2-oxazoline), modified starch cellulose; and cellulose derivatives, and mixtures thereof.

18. The ink-jet recording medium of claim 16, wherein the ink-receptive underlayer comprises polyvinyl alcohol and silica.

19. The ink-jet recording medium of claim 16, wherein the ink-receptive underlayer comprises pigment and a water-dispersible polymer selected from the group consisting of acrylates; methacrylates; polyvinyl acetate; vinyl acetate copolymers, polystyrene; styrene copolymers; polyesters; vinyl-acrylic terpolymers, polyacrylonitrile; acrylonitrile copolymers, polyurethanes; and
mixtures thereof.

20. The ink-jet recording medium of claim 16, wherein the substrate is a paper.

21. The ink-jet recording medium of claim 16, wherein the weight of the ink-receptive underlayer is in the range of about 5 to about 20 g/m² and the weight of the ink-receptive top layer is in the range of about 5 to about 40 g/m².

22. The ink-jet recording medium of claim 16, wherein the paper is a substantially impermeable paper having a polymeric moisture barrier coating.

23. The ink-jet recording medium of claim 16, wherein the substrate is a polymeric film comprising a polymer selected from the group consisting of polyesters, polycarbonates, polyethylene, polypropylene, polyvinyl chloride, polystyrene, polyacrylics, polyacetals, ionomers, and mixtures thereof.

24. The ink-jet recording medium of claim 16, wherein the substrate is a metal foil.

25. The ink-jet recording medium of claim 16, wherein the substrate is a metal-coated material.

26. A method of making an ink-jet recording medium, comprising the steps of a) coating a substrate with an ink-receptive underlayer comprising a pigment and polymer selected from the group consisting of water-soluble and water-dispersible polymers, and drying the underlayer; and
b) coating an ink-receptive top layer over the underlayer, said top layer comprising an aqueous dispersion of: a) at least 60% by weight of cationic fumed silica particles and b) at least 14% by weight of cationic polyurethane resin based on total weight of solids in the dispersion, and drying the top layer.

27. The method of claim 25, wherein the ink-receptive layers are applied using a Meyer-rod, slot-die, roller, blade, wire bar, dip, solution extrusion, reverse roll, air-knife, curtain slide, doctor-knife, and gravure method.

28. The method of claim 25, wherein the ink-receptive top layer is not calendered, said top layer having a surface gloss of 10 or greater.

29. The method of claim 25, wherein the ink-receptive top layer is calendered, said top layer having a surface gloss of 20 or greater.
